(19) United States
(12) Patent Application Publication
(10) Pub. No.: US 2007/0179006 A1
(43) Pub. Date: Aug. 2, 2007

(54) PREASSEMBLED DRIVE UNIT FOR AN ADJUSTABLE FUNCTIONAL ELEMENT IN A MOTOR VEHICLE

(75) Inventor: Checrallah Kachouh, Dortmund (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/627,081

(22) Filed: Jan. 25, 2007

(30) Foreign Application Priority Data
Jan. 25, 2006 (DE) 10 2006 001 250.8

(51) Int. Cl. F16H 48/06

(52) U.S. Cl. 475/154

(57) ABSTRACT

A preassembled drive unit for an adjustable functional element in a motor vehicle has a drive motor (1) and a braking device (2). A drive connection (3) is provided for producing the driving force or driving torque of the drive motor (1) and a brake connection (4) is provided for producing the braking force or braking torque of the braking means (2).

### BACKGROUND OF THE INVENTION

1. Field of the Invention

The invention relates to a preassembled drive unit for an adjustable functional element in a motor vehicle with a drive motor and a braking means, and to a drive with such a drive unit.

2. Description of Related Art

The drive unit under consideration is used within the framework of motorized adjustment of functional elements in a motor vehicle. Such a drive unit can be for example part of the drive for a hatch, a cover, a hood, a side door, a sliding door or the like of a motor vehicle.

A known drive for a motor vehicle or hatch (German Utility Model DE 20 2004 016 542 U1; U.S. Patent Application Publication 2005/0277512 A1) is equipped with a drive motor which is coupled to a planet gear. In one alternative, the motor shaft of the drive motor is connected to the sun wheel of the planet gear. In this connection, there is a braking means by which the hollow wheel of the planet gear can be braked. The planet carrier of the planet gear constitutes the output drive here.

The disadvantage in the known drive is the fact that the structure has very little compactness and requires high installation effort. Furthermore, a modular structure of the drive with the components used there is hardly possible.

### SUMMARY OF THE INVENTION

A primary object of the invention is to embody and develop the components of a drive of the initially mentioned type such that simple installation, and a modular and compact structure are insured.

This object is achieved by a preassembled drive unit being provided with a drive connection for providing the driving force or the driving torque of the drive motor and a brake connection for providing the braking force or braking torque of the braking means.

Here, “preassembled” means that the drive unit can be otherwise completed separately from the drive and need simply be connected via a corresponding mechanical interface during installation.

What is important is to combine a drive motor, on the one hand, and a braking means, on the other, in a preassembled drive unit. It has been recognized that the drive function and the brake function must often be made available at almost the same location. One example of this was given in the introductory part of the specification in which the sun wheel of the planet gear is driven and the hollow wheel of the planet gear must be braked.

At this point, there are a drive connection for providing the driving force or the driving torque of the drive motor for a component to be driven and a brake connection for providing the braking force or braking torque of the braking means for a component which is to be braked.

In this connection, the component to be driven can be the functional element which is to be moved by a motor. However, it can also be that the component to be driven is the drive side of a clutch or a gear which is then coupled on the driven side to the functional element by drive engineering.

The braking function can be used in this connection, on the one hand, for mechanical triggering of a clutch. One example of this is the above described braking of the hollow wheel of the planet gear with a sun wheel which is driven. However, the braking function can also be used to brake the movement of the functional element in itself. This corresponds to the braking function in the conventional sense.

The component to be driven, the component to be braked and the functional element in the aforementioned sense can be different components which are optionally coupled to one another by drive engineering via a gear, a clutch, or the like. However, in certain applications, it can also be provided that the component to be driven, the component to be braked and the functional element are in part identical in the aforementioned sense.

In preferred configurations, the drive connection and the brake connection are rotary connections to which a drive shaft and brake shaft are assigned.

The preferred configuration in which the brake shaft is a hollow shaft and wherein the brake shaft is penetrated by the drive shaft is especially compact. Here, it can also be provided that the drive shaft and the brake shaft are to a certain extent arranged in succession. The penetrated configuration is optimum with respect to the attainable compactness.

In a preferred configuration, the drive shaft, on the one hand, and the brake shaft, on the other, are coupled to the assigned elements of a planet gear. In this way, the function of a clutch which can be triggered by a braking means has been added to the drive unit. Here, it is especially advantageous if the hollow shaft of the braking means is assigned to the hollow wheel of the planet gear, preferably connected to it. It can even be such that the brake shaft which is made as a hollow shaft is identical to the hollow wheel of the planet gear. Preferably, the sun wheel of the planet gear is coupled to the drive motor. The planet carrier then forms the output drive.

According to another teaching which has independent importance, a drive for an adjustable functional element in a motor vehicle has a drive unit in the aforementioned sense and a downstream spindle-spindle nut gear. This drive can be used especially advantageously for motorized adjustment of hatches or doors of motor vehicles. A configuration of the drive unit wherein the drive shaft and brake shaft are arranged coaxially to one another is especially advantageous here with respect to obtaining of a slender construction.

Other details, features, objectives and advantages of this invention are explained in detail below with reference to the accompanying drawings which show preferred embodiments of the invention.

### BRIEF DESCRIPTION OF THE DRAWINGS

FIG. 1 is a schematic depiction of a preassembled drive unit in accordance with the invention in a cutaway side view,

FIG. 2 is a view similar to that of FIG. 1, but showing another preassembled drive unit in accordance with the invention,

FIG. 3 shows another preassembled drive unit in accordance with the invention in a view as shown in FIG. 1,

FIG. 4 shows another preassembled drive unit in accordance with the invention in a view shown in FIG. 1, and

FIG. 5 shows a drive of a hatch of a motor vehicle with a drive unit according with the invention.

### DETAILED DESCRIPTION OF THE INVENTION

The preassembled drive unit shown in the drawings is preferably used as a component of a drive for an adjustable functional element. Examples of these functional elements in a motor vehicle are given below.

The drive unit is equipped with a drive motor 1 and a braking means 2. The drive motor 1 is used to produce a driving force or driving torque which causes movement of the functional element of the motor vehicle. The braking means 2 provides a braking force or a braking torque which can be used differently in this connection. This was explained in the Background part of this specification. Accordingly, the drive connection 3 is designed to provide the driving force or driving moment of the drive motor 1 for a component I a to be driven and the brake connection 4 is designed to provide the braking force or braking torque of the braking means 2 for a component 2a which is to be braked.

The component 1a to be driven in the aforementioned sense can be the functional element itself. However, it can also be provided that a gear (or other transmission element) is interposed so that the component 1a to be driven is the input shaft or the like of the interposed gear. The component 2a to be braked can be a component of a clutch or the component 1a to be driven or the functional element. One example of this is given below.

FIGS. 1 & 2 show that, for both preferred embodiments, the drive unit is a closed, separate preassembled unit. The installation of the drive unit is thus limited to its connection via the drive connection 3 and the brake connection 4 and to the corresponding mechanical attachment.

Basically, it can be provided that the drive motor 1 produces linear drive motions. However, in a preferred configuration, the drive motor 1 is a rotary motor. Accordingly, the drive connection 3 preferably has a drive shaft 5 via which the component 1a to be driven can be connected and which can be driven by means of the drive motor 1.

The same applies to the braking means 2. However, basically, it can be that the braking means 2 provides a braking force which acts only in one direction. In a preferred configuration, the braking means 2 provides a braking torque. Accordingly, preferably, the brake connection 4 has a brake shaft 6 via which the component to be braked 2a can be connected and which can turn freely when the braking means 2 is in the released state and is braked when the braking means 2 is in the braking state.

Depending on the application, different arrangements of the shaft axes of the drive shaft 5 and the brake shaft 6 are advantageous. Especially versatile applicability results from the shaft axes of the drive shaft 5 and the brake shaft 6 being spaced apart from one another and preferably parallel to one another. This is shown by FIG. 1. However, it can also be provided that the shaft axes of the drive shaft 5 and the brake shaft 6 are arranged at an angle to one another, preferably offset by 90°.

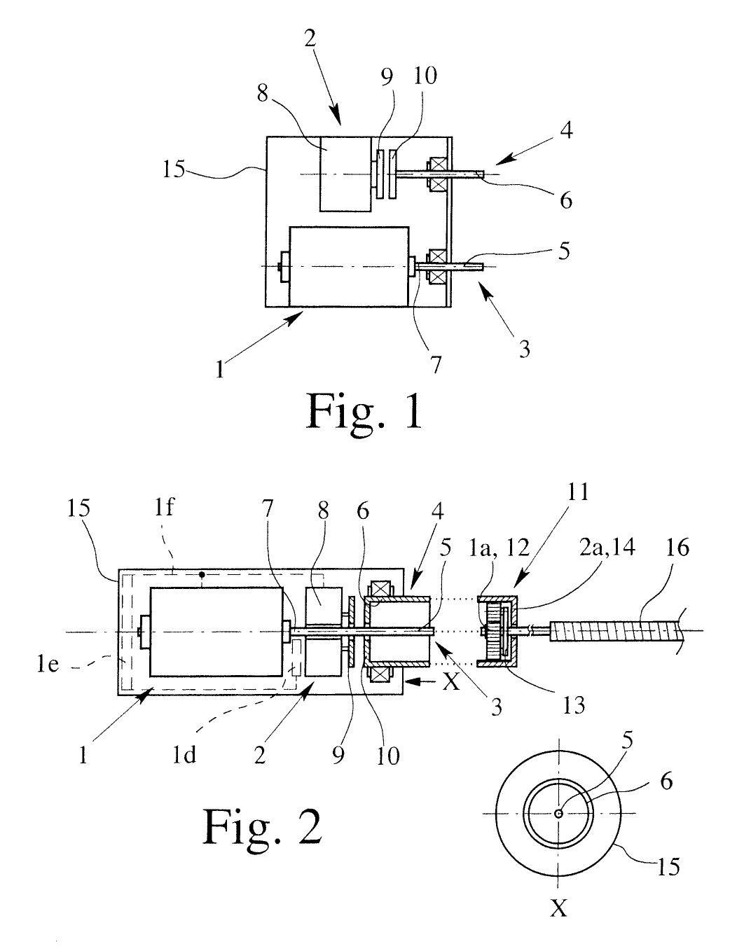

An especially compact configuration arises from the fact that the brake shaft 6 is made as a hollow shaft. This is shown in FIG. 2. In this way, the brake shaft 6 is penetrated by the drive shaft 5 which is preferably a solid shaft, as likewise shown in FIG. 2. By this “inter-nesting” of the drive motor 1 and braking means 2, the packing density of the drive unit is especially high and the required installation space is especially low. Here, the drive shaft 5 and brake shaft 6 are arranged coaxially to one another in an especially preferred configuration.

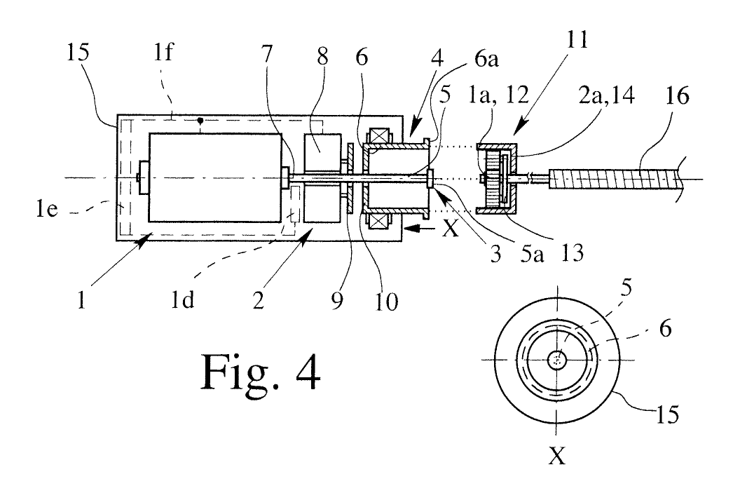

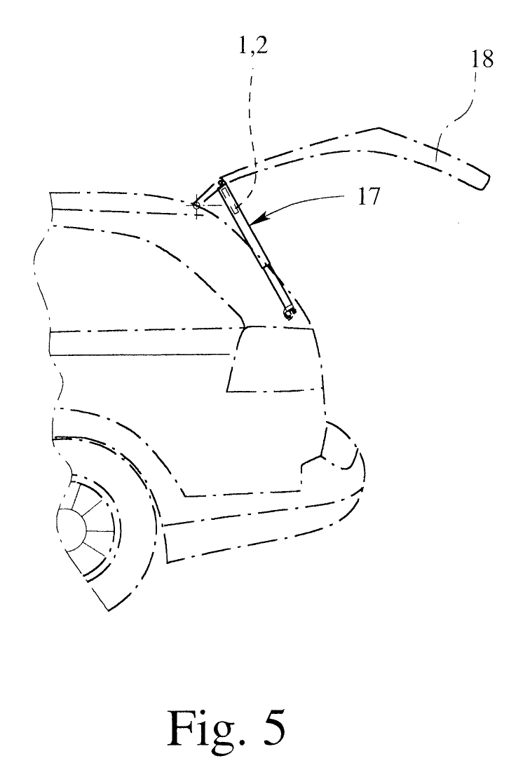

Low installation cost can be expected when the drive connection 3 and the brake connection 4 each have a flange 5a, 6a and that the two flanges 5a, 6a are arranged essentially in a single plane, this plane preferably being aligned perpendicular to the axis of the drive shaft 5 (FIG. 4). This supports an essentially inherently closed type of construction of the drive unit which, in turn, leads to high compactness. It is to be noted that the above flanges 5a, 6a need not be only a rib or rim for attachment in the conventional sense of the term “flange,” but rather these flanges can be realized as attachment elements of any kind that is suitable for the drive shaft 5, on the one hand, and for the brake shaft 6. on the other hand.

Numerous versions for the configuration of the drive motor 1 are possible. For example, the drive motor 1 can be made as an electric motor, as a pneumatic motor or as a hydraulic motor, which has a motor shaft 7. It is important here that the motor shaft 7 is somehow coupled to the drive shaft 5.

The coupling between the motor shaft 7 and the drive shaft 5 can be provided directly or indirectly. One example of indirect coupling is a gear being connected between the motor shaft 7 and the drive shaft 5. Here, all conceivable versions of gears can be used. The use of a planet gear is feasible for the purpose of a compact arrangement.

The braking means 2 can be made as an active braking means 2 or as a passive braking means. In the active configuration, the braking means 2 is equipped with a brake drive 8 and a brake element 9, and the brake element 9 can be shifted into brake-engagement by means of the brake drive 8, preferably, with the brake shaft 6 or a component which is coupled to the brake shaft 6. In the illustrated and preferred embodiments, the brake element 9 can be caused to engage a brake disk 10 which is attached to the brake shaft 6. For this purpose, the brake element 9 can be deflected to the right in the drawings.

In a preferred configuration, the braking means 2 is made as an electromagnetic braking means. This means that the brake drive 8 preferably has an electromagnet and possibly a permanent magnet.

It is especially advantageous when the braking means 2 can be moved into several brake states in which it provides different braking forces or braking torques. In such a case, the braking means 2 can continuously provide the braking force or braking torque in a wide range. However, it is also possible to provide the braking force or braking torque incrementally.

An especially preferred configuration which can be easily implemented with the illustrated drive units is for the braking means 2 to be able to be moved into a total of three states, specifically into two braking states and one released state.

First of all, the braking means 2 can be moved into the full braking state in which the braking torque is high. The “high” braking torque is defined as the case in which rotation of the brake shaft 6 is not possible in proper use.

The braking means 2 can also be brought into a half-braked state in which the braking torque is low. “Low” braking torque is defined as the state in which rotation of the brake shaft 6 is possible in proper use and with the corresponding torque application.

With respect to the configuration of the braking means 2 with two braking states and one released state, reference should be made to the aforementioned German Utility Model 20 2004 016 542 U1 and U.S. Patent Application Publication 2005/0277512 A1 which are commonly owned and the contents of which are hereby fully incorporated by reference into this application.

In order to further increase the compactness of the drive unit, it is preferably provided that the drive motor 1 and the braking means 2 be partially combined. The basic approach here is to use the magnetic fields provided both for the drive motor 1 and also the braking means 2 several times to a certain extent.

In the configuration of the drive motor 1 as an electric motor, fundamentally, any type of magnetic field is provided for motor operation, regardless of the type of electric motor. In the configuration of the braking means 2 as an electromagnetic braking means 2, there is likewise a magnetic field, here for brake operation.

The drive motor 1, on the one hand, and the braking means 2, on the other, are configured and arranged such that the aforementioned magnetic fields, in any case, are in part superimposed and with a corresponding configuration can be used both for motor operation and also for brake operation. It can also be provided that the magnetic fields are completely superimposed so that, as a result, only a single magnetic field exists. It is also possible that the magnetic field provided for motor operation is, in any case, partially identical to the magnetic field provided for brake operation.

One preferred configuration comprises the drive motor 1 being assigned a permanent magnet 1b and that the permanent magnet 1b assigned to the drive motor 1 is assigned, at the same time, to the braking means 2. One example of this is that the drive motor 1 is made as a direct current motor which is permanently excited. This means that the drive motor 1 is assigned a fixed permanent magnet 1b which produces the magnetic field which is necessary for motor operation.

The braking means 2, especially the brake drive 8, is preferably equipped with an electromagnet with a coil. Current flow through the coil causes movement of the ferromagnetic brake element 9. In order to be able to provide for example the above described two brake states, conventionally there is a permanent magnet here with a magnetic field which likewise causes the action of a force on the brake element 9, which force can be amplified or attenuated by the coil. This can be taken from the above-referenced German Utility Model 20 2004 016 542 U1 and U.S. Patent Application Publication 2005/0277512 A1.

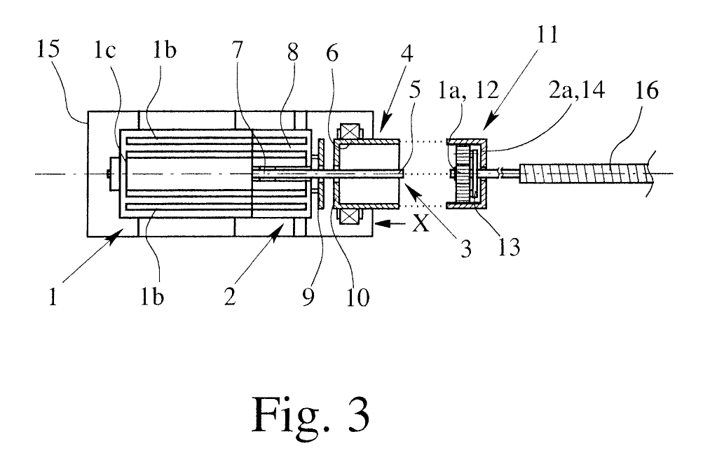

In a preferred configuration, it is provided here that the permanent magnet of the braking means 2 is omitted, and for this purpose, the magnetic field of the permanent magnet 1b of the drive motor 1 is used. This saves one permanent magnet and installation space (FIG. 3).

However, it can also be provided that the drive motor 1 is assigned a coil 1c for producing a magnetic field and that the coil 1c assigned to the drive motor 1 is, at the same time, assigned to the braking means 2, especially the brake drive 8 (FIG. 3). This can be implemented especially easily when the drive motor 1 is a direct current motor with a field winding-coil.

In the latter embodiments, the permanent magnet 1b assigned to the drive motor 1 and/or the coil 1c assigned to the drive motor 1 is also assigned to the braking means 2. This is, of course, also applicable in the reverse. It is important here that a permanent magnet 1b and/or a coil 1c is or are assigned both to the drive motor 1 and also the braking means 2. The permanent magnet 1b and the coil 1c can optionally also be arranged separately from the drive motor 1 and also from the braking means 2, for example, between the drive motor t and the braking means 2.

In all versions which provide for multiple use of the magnetic field by the drive motor 1, on the one hand, and the braking means 2, on the other, it is advantageously such that the repeatedly used magnetic field penetrates both the drive motor 1 and also the braking means 2, especially the brake drive 8 along a straight line. The drive motor 1 and the braking means 2 are aligned both along this line. This is shown, for example, in FIG. 2.

In the passive configuration of the braking means 2, the braking means 2 is not equipped with its own brake drive. In this connection, it the braking means 2 can be moved by external actuation into a released state and into a braking state. For example, there can be a lever linkage or Bowden cable linkage for this purpose. However, it is also possible for the external actuation to be caused by a drive motor 1, for example, by the starting of the drive motor 1. The braking means 2 is then preferably made as an overrunning spring brake which is suitably engaged to the drive motor 1. The actuation of the braking means 2 by the drive motor 1 is especially advantageous when the braking means 2 is used to actuate a downstream clutch 11.

The indicated clutch 11 is preferably a controllable, and furthermore, preferably, a switchable clutch 11 which is connected or can be connected to the drive connection 3 and to the brake connection 4. In this respect, the arrangement is such that the clutch 11 can be controlled or switched by the braking means 2.

The clutch 11, in the aforementioned sense, can be a correspondingly connected planet gear. This is indicated in FIG. 2. The horizontally broken lines are in schematic form for the corresponding attachments.

The planet gear 11 is conventionally equipped with elements including a sun wheel 12, planet carrier 13 and hollow wheel 14. In this connection, one of the sun wheel 12, planet carrier 13 and hollow wheel 14 elements are coupled to the drive shaft 5. A second of these elements is coupled to the brake shaft 6. The third of the sun wheel 12, planet carrier 13 and hollow wheel 14 elements is used as the output drive. The output drive is generally coupled to the functional element of the motor vehicle which is to be moved.

In the preferred configuration shown in FIG. 2, the sun wheel 12 is coupled to the drive shaft 5 and the hollow wheel 14 is coupled to the brake shaft 6. The planet carrier 13 is used here as an output shaft for the functional element to be moved. Therefore, the component 1a to be driven in the aforementioned sense is the sun wheel 12, the component 2a to be braked conversely is the hollow wheel 14.

The latter configuration is especially advantageous in a design aspect when the brake shaft 6 is made as a hollow shaft, as is shown in FIG. 2. Because the brake shaft 6, which is made as a hollow shaft, fundamentally, has the form of the hollow wheel 14 of the planet gear, here, coupling between the brake shaft 6 and hollow wheel 14 is especially easy. It can even be provided that the hollow wheel 14 be formed by the brake shaft 6 which is made as a hollow shaft. This has already been addressed above. The result is an especially compact arrangement.

The preferred configuration of the braking means 2 addressed above with two braking states and one released state can be advantageous in the aforementioned configuration with a clutch 11 which is made preferably as a planet gear. In the fully braked state, there is exclusively motorized adjustment of the assigned functional element. In the released state, the functional element can be freely moved, therefore, for example, in the case of a hatch, it can shut uncontrolled. For this case, the half-braked state is advantageous, in which the functional element is held, but still can be moved with application of a corresponding torque. In this connection, it is assumed that the drive motor 1 or the drive motor 1 and an optionally downstream gear between the motor shaft 7 and the drive shaft 5 are made self-locking. Here, reference should also be made to the above referenced German Utility Model 20 2004 016 542 U1 and U.S. Patent Application Publication 2005/0277512 A1.

In another preferred configuration, a common drive housing 15 or common support frame is provided for the drive unit which, in any case, holds the drive motor 1 and the braking means 2. In this connection, it is also preferably provided that, otherwise, neither the drive motor 1 nor the braking means 2 have their own housing. This corresponds to the basic consideration of making the drive unit as a closed, separately preassembled module.

To trigger the drive motor 1 and the brake drive 8 in a preferred configuration, there is an electronic means 1e which is advantageously located in the drive housing 15. This can result in the drive unit forming a self-contained unit which provides certain control engineering functions by means of integrated control. Optionally, the control can also have a bus communications module via which the drive unit can be addressed then by a higher-level control.

Depending on the application, it can be advantageous to monitor both motor operation of the drive motor 1 and also brake operation of the braking means 2 by sensors. For purposes of high compactness, preferably, sensor monitoring of the drive motor 1 is combined with sensor monitoring of the braking means 2. In this connection, there is a sensor arrangement 1d for monitoring the drive motor 1 and that the same sensor arrangement 1d is intended for monitoring the braking means 2.

One example of this is the use of a proximity sensor which interacts, on the one hand, with the drive shaft 5, and on the other hand, with the brake element 9 such that the signals of the proximity sensor provide information about the rotation of the drive shaft 5 and also the adjustment of the brake element 9.

The drive motor 1 and the brake drive 8 can be supplied with electricity in a preferred configuration. Then, it is advantageous if there is combined wiring 1f, which reduces wiring cost. When the supply line of the drive motor 1 and the supply line of the brake drive 8 are series connected, moreover, there is additional safety in case of a cable break or when one of the two components fails. Thus it is ensured, specifically with the corresponding design, that both the drive motor 1 and also the brake drive 8 or neither the drive motor 1 nor the brake drive 8 provides the corresponding forces or torques.

In order to further simplify installation of the drive unit, on one side of the drive unit there are contact elements, and by means of a common plug or the like, contact can be made with the contact elements, and thus, both the drive motor 1 and also the braking means 2. In a preferred configuration, it is a plug which also ensures linkage of the control.

Furthermore, it was pointed out above that the drive unit is preferably a component of a drive 17, which is shown in FIG. 4 in its entirety, in a motor vehicle. In a preferred configuration, the drive unit is a component of the drive 17 of a hatch 18, a cover, a hood, side door, a sliding door or the like of a motor vehicle. However, basically, the drive 17 can also be assigned to all conceivable functional elements of a motor vehicle. Another example of this is the seat or the like of a motor vehicle.

In a preferred configuration, the drive is equipped with a spindle-spindle nut gear which is connected downstream of the drive unit. Especially for the configuration shown in FIG. 2, this leads to a slender version of the drive. The spindle 16 of the spindle-spindle nut gear, which is not further shown, is coupled to the planet carrier 13 of the planet gear 11. The drive as such is the subject matter of another teaching which acquires independent importance.

What is claimed is:

1. Preassembled drive unit for an adjustable functional element in a motor vehicle, comprising:
a drive motor,
a braking means,
a drive connection for providing the driving force or torque of the drive motor, and
a brake connection for providing the braking force or torque of the braking means.

2. Preassembled drive unit as claimed in claim 1, wherein the drive connection has a drive shaft via which a component to be driven can be connected and which is drivable by means of the drive motor.

3. Preassembled drive unit as claimed in claim 2, wherein the brake connection has a brake shaft via which the component to be braked can be connected and which can turn freely when the braking means is in a released state and is braked when the braking means is in a braking state.

4. Preassembled drive unit as claimed in claim 3, wherein shaft axes of the drive shaft and the brake shaft are spaced apart from one another.

5. Preassembled drive unit as claimed in claim 3, wherein the drive shaft and brake shaft are arranged coaxially relative to one another.

6. Preassembled drive unit as claimed in claim 5, wherein the brake shaft is a hollow shaft and wherein the brake shaft is penetrated by the drive shaft.

7. Preassembled drive unit as claimed in claim 1, wherein the drive connection and the brake connection each have a flange and wherein the flanges are arranged essentially in a single plane, and wherein the plane is aligned perpendicular to the axis of the drive shaft.

8. Preassembled drive unit as claimed in claim 6, wherein the drive connection and the brake connection each have a flange and wherein the two flanges are arranged essentially in a single plane and wherein the plane is aligned perpendicular to the axis of the drive shaft.

9. Preassembled drive unit as claimed in claim 2, wherein the drive motor is made as one of an electric motor, a pneumatic motor and a hydraulic motor which has a motor shaft and wherein the motor shaft is coupled to the drive shaft.

10. Preassembled drive unit as claimed in claim 2, wherein a gear is connected between the motor shaft and the drive shaft.

11. Preassembled drive unit as claimed in claim 3, wherein the braking means has a brake drive and a brake element and wherein the brake element is movable into braking engagement by means of the brake drive with the brake shaft or a component which is coupled to the brake shaft.

12. Preassembled drive unit as claimed in claim 1, wherein the braking means is an electromagnetic braking means.

13. Preassembled drive unit as claimed in claim 1, wherein the braking means is movable into several braking states in which it provides different braking forces or torques.

14. Preassembled drive unit as claimed in claim 3, wherein the braking means is movable into a full braking state in which the braking torque is high and rotation of the brake shaft prevented and wherein the braking means is movable into into a half-braked state in which the braking torque is low and rotation of the brake shaft is possible with a corresponding torque application.

15. Preassembled drive unit as claimed in claim 1, wherein there is a magnetic field for motor operation by the drive motor, wherein there is a magnetic field for brake operation by the braking means and wherein the magnetic fields are each in part superimposed.

16. Preassembled drive unit as claimed in claim 1, wherein a permanent magnet is assigned to the drive motor and wherein the permanent magnet assigned to the drive motor is also assigned to the braking means.

17. Preassembled drive unit as claimed in claim 1, wherein a coil is assigned to the drive motor for producing a magnetic field and wherein the coil assigned to the drive motor is also assigned to the braking means.

18. Preassembled drive unit as claimed in claim 1, wherein a controllable clutch is connected or connectable to the drive connection and to the brake connection, and wherein the clutch is controlled by the braking means.

19. Preassembled drive unit as claimed in claim 3, wherein a planet gear is connected to the drive shaft and the brake shaft, the planet gear having a sun wheel element, a planet carrier element and hollow wheel element, wherein one of said elements is coupled to the drive shaft, wherein a second of said elements is coupled to the brake shaft, and wherein a third of said elements forms an output drive.

20. Preassembled drive unit as claimed in claim 1, further comprising a common drive housing or support frame which holds both the drive motor and the braking means.

21. Preassembled drive unit as claimed in claim 1, wherein the drive motor and the brake drive have a combined wiring for supplying electricity thereto.

22. Preassembled drive unit as claimed in claim 1, wherein the drive unit is a component of a drive of a motor vehicle and wherein the drive is adapted for motorized movement of one of a hatch, a cover, a hood, a side door, a sliding door of the motor vehicle.

23. Preassembled drive unit as claimed in claim 1, wherein the drive unit is a component of the drive of a seat of a motor vehicle.

24. Preassembled drive unit as claimed in claim 1, wherein the drive has a spindle-spindle nut gear which is connected downstream of the drive unit.

25. Drive for an adjustable functional element in a motor vehicle, comprising:
a drive unit, and
a spindle-spindle nut gear connected downstream of the drive unit,
wherein the drive unit is a preassembled unit having a drive motor and a braking means, the drive unit having a drive connection for providing the driving force or torque of the drive motor and a brake connection for providing the braking force or torque of the braking means.

26. Drive as claimed in claim 25, wherein the drive connection has a drive shaft via which a component to be driven is connectable for being driven by means of the drive motor and wherein the brake connection has a brake shaft via which the component is connectable and which can turn freely when the braking means is in a released state and is braked when the braking means is in a braking state.
